(19) United States
(12) Patent Application Publication
(10) Pub. No.: US 2010/0087981 A1
(43) Pub. Date: Apr. 8, 2010

(54) VERSATILE VEHICULAR CARE ASSISTANT SYSTEM AND METHOD

(76) Inventor: Daniel Guadalupe Orozco-Perez, Cedar Park, TX (US)

Correspondence Address: Daniel Orozco-Perez, 410 Mandarin Flyway, Cedar Park, TX, 78613, US

(21) Appl. No.: 12/243,973

(22) Filed: Oct. 2, 2008

(51) Int. Cl. G06F 19/00

(52) U.S. Cl. 701/30; 701/33

(57) ABSTRACT

A wireless system aimed to assist in vehicle care and operation is described. The system is based on wireless mesh networking technology, integrating in-vehicle (mobile) and in-location (stationary) wireless intranets. Each intranet comprises a short range wireless networking between a plurality of intranet points unit (IPU), each tied to an electronic data input/output device (EDD), and a network hub point. Each IPU obtains data from respective attached EDD to be locally processed and stored for transmission to the associated network hub point on request. A network hub point collects data from respective IPUs, communicates with other intranets, and provides system user interface functions for user interaction.

### CROSS-REFERENCE TO RELATED APPLICATIONS

| | | |
|---|---|---|
| U.S. Pat. No. 4,359,714 | Nov. 16, 1982 | Tsunoda et al. |
| U.S. Pat. No. 4,989,146 | Jan. 29, 1991 | Imajo |
| U.S. Pat. No. 5,661,651 | Aug. 26, 1997 | Geschke et al. |
| U.S. Pat. No. 5,859,628 | Jan. 12, 1999 | Ross et al. |
| U.S. Pat. No. 6,127.947 | Oct. 3, 2000 | Uchida et al. |
| US 2001/0012976 A1 | Aug. 9, 2001 | Menig et al. |
| U.S. Pat. No. 6,301,531 B1 | Oct. 9, 2001 | Pierro et al. |
| U.S. Pat. No. 6,526,335 B1 | Feb. 25, 2003 | Treyz at al. |
| U.S. Pat. No. 6,668,219 B2 | Dec. 23, 2003 | Hwang et al. |
| U.S. Pat. No. 6,928,345 B2 | Aug. 9, 2005 | Quinn |
| US 2006/0217848 A1 | Sep. 28, 2006 | Oesterling et al. |
| U.S. Pat. No. 7,116,221 B2 | Oct. 3, 2006 | Addy |
| US 2008/0027604 A1 | Jan. 31, 2008 | Oesterling |
| U.S. Pat. No. 7,346,374 B2 | Mar. 18, 2008 | Witkowski et al. |

### OTHER PUBLICATIONS

Edward Nelson, Defining Interfaces as Services in Embedded Vehicle Software, Research and Advanced Engineering, Ford Motor Company, January 2004, Automotive Software Workshop San Diego.
Edward Nelson and Henry Huang, A Software and System Modeling Facility for Vehicle Environment Interactions, March 2006, Second Automotive Software Workshop San Diego, Model-Driven Development of Reliable Automotive Services, ISSN 0302-9743 (Print) 1611-3349 (Online), volume 4922/2008, pp 34-47.

### FEDERALLY SPONSORED RESEARCH

Not Applicable

### SEQUENCE LISTING OR PROGRAM

Not Applicable

### FIELD OF THE INVENTION

This invention relates generally to a non-intrusive, customizable wireless communication system aimed at supervising automotive vehicle conditions, assisting with predetermined schedule vehicular related matters, security and efficient operation.

### DESCRIPTION OF PRIOR ART

Conventionally, modern automobiles provide built-in capabilities incorporating complex electronic devices and systems for driver safety and vehicle drivability. In a vehicle malfunction event, diagnostic electronic devices have been developed to alert the driver of a critical failure or a service related warning. As such, while the driver is alerted, the information provided is confined to vehicle category and automaker, represented through different means like warning lamps, alarm buzzers or chimes, small displays embedded in vehicle dashboard, or even static voice prompts for predetermined conditions. Usually, the alert messages are activated intermittently, for non-critical issues, or indefinitely until repaired. Such alert messages are coded, requiring the use of specialized troubleshooting equipment to get further details about a failure, to carry out a repair procedure recommended by respective automaker. Ultimately, vehicle owners face the inconvenience of being partially informed, relying every time on an auto service shop to diagnose the condition. In general, the vast number of electronic products and systems for vehicle anomaly diagnostic are neither compatible across different car makers nor backwards compatible with older models.

A wide variety of improved in-vehicle products and systems have been designed and developed, including car safety in all conditions, car maintenance minding, OBD-II/CAN plug-in diagnostic scanners and loggers, remote roadside assistance, car navigation assistance, real time road conditions information, and adapted personal computers featuring remote communications to provide driving comfort and diagnostics support while driving. As such, those with cars equipped with such in-vehicle systems could be distracted and overwhelmed by different sources of information diverting attention from the road.

The present invention overcomes these disadvantages and advances the state of the art in vehicle security and vehicle care systems with an enhanced user interface experience, also, provides an interface that is independent of build-in specific hardware in the vehicle such that can be installed from low-end to high-end vehicles across different automakers.

### BRIEF SUMMARY OF THE INVENTION

In accordance with one exemplary embodiment, a flexible intra-micro-wireless network system is described. The system comprises a short range wireless communication network comprising a plurality of intra point units (IPU), each tied to an electronic data input/output device (EDD, e.g., geographical coordinate device, in-vehicle diagnostics interface, in-vehicle bus interface, residential security alarm trigger element, binary or analog sensor, binary or analog actuator), and a hub node. A hub node is a network hub point used for IPU data collection and processing, communications with other compatible network hub points, and provides system user interface functions for user interaction. Each IPU obtains data from respective attached EDD to be locally processed and stored for transmission to the associated hub node on request.

According to a first embodiment of the invention, onboard vehicle assistant system (OVAS) is presented to detect in-vehicle and vehicle surrounding circumstances to be efficiently conveyed to the owner or driver in a visual and audible form. The vehicle related information includes maintenance schedule cautions, official motor vehicle obligations schedule alerts, operating statistics generation, home and public parking security, location awareness messages, critical driving logging, and on the road companion alerts. OVAS system comprises an in-vehicle mobile point unit (MPU) as the hub node controller, which process data collected from all respective IPUs and determines audible and visual output information to the driver based on vehicle trip status, current location, and date and time during the day. The MPU could also communicate wirelessly, within the coverage area, to other compatible hub nodes MPU or SPU placed at different premises such as residential/office places, auto shops, and public places including parking areas.

A second embodiment of the invention, in-location assistant system (ILAS), could perform applications such as: (1) gateway to in-location networked computer; (2) hub node interacting with respective in-location IPUs and engaged MPUs; or (3) stand-alone device where the SPU is tied to a sensor or actuator device. ILAS system comprises an in-location stationary point unit (SPU) as the hub node controller, which exchanges specific information corresponding to its particular function at the site where placed.

The invention further includes an embedded system with flexible hardware and software architecture to facilitate the embodying of numerous wireless network point units including IPUs and hub nodes. The embedded system represented as a circuit board could be assembled and programmed to embody MPU, SPU, or IPU network point units.

The invention also encompasses a method for gathering and processing data to generate concise prioritized messages based on pre-configured unit behavior database, comprising the steps of:
a) detecting vehicle trip status trigger event transition;
b) seeking tagged with ready system messages matching current vehicle trip status;
c) generating “greeting” messages according with current vehicle conditions, time and date; and
d) activating “greeting” message when request is acknowledged by the vehicle owner or occupant, followed by system messages conveyed from highest to lowest priority level.

The described above method could be used by a wireless communication network hub node. Each hub node can have a customized behavior database to accomplish specific application requirements. For instance, a MPU could use this method to supervise automotive vehicle matters and convey system messages to the driver, suggesting some correction or maintenance action, or just informative or greeting messages.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a schematic representation of OVAS and ILAS wireless intranets interaction, showing communication links with respective IPUs.

FIG. 2 is a block diagram of OVAS wireless intranet depicting details of numerous in-vehicle IPUs, as well as interaction with other network hub points via extra-wireless link.

FIG. 3 is a block diagram of ILAS wireless intranet depicting details of multiple in-location IPUs, as well as interaction with other network hub points via extra-wireless link.

FIG. 4 is a block diagram of a configurable embedded wireless hardware platform for specific network point unit embodiment.

FIG. 5 illustrates a block diagram of generic-network point unit software architecture as well as behavior database segments with respective field elements.

FIG. 6 shows system and inter-network message header definitions.

FIG. 7 illustrates the data router thread flowchart.

FIG. 8 illustrates the data logger thread flowchart.

FIG. 9 illustrates the vehicle trip state machine.

FIG. 10 illustrates the message dispatcher thread flowchart.

FIGS. 11A and 11B shows the sleep and wake up threads flowcharts respectively.

FIG. 12 shows preferred in-vehicle MPU installation.

### DETAILED DESCRIPTION OF THE EXEMPLIFICATION EMBODIMENTS

The following terms used herein have the ascribed meanings. The term “flexible interface” refers to an extension of control signals and a programmable interface (e.g., UART, serial peripheral interface (SPI), digital input/output, analog input/output) to interconnect, through a custom communication board, an EDD or suitable embedded components. The term “embedded devices” connotes a set of integrated circuits interconnected and soldered on a board unit to provide specific functionality (e.g., vehicle inertia data, temperature, real time clock (RTC)). “User interface” term relate to those electronic devices by which a person interacts with OVAS or ILAS (e.g., graphic display, audible voice sounds, joystick, touch sensitive components). “Baseband microcomputer” (BBM) refers to the core processing unit which includes a microcontroller, memory, and a physical layer interface with radio frequency (RF) component. “Driver” suggests a person that owns and/or drives a vehicle. The term “collecting data” first, involves an establishment of a wireless communication channel between a network hub point (e.g., MPU or SPU) and a network end point (e.g., IPU), then, an exchange of messages to request specific data. This sequence is repeated with every respective network end point until all data required at a given time is gathered, stored and ready for processing. The term “obtaining data” refers to an IPU exchanging data messages with tied EDD, then, filtering and storing acquired data for future transmission to respective network hub point (e.g., MPU or SPU) on request. The term “computer” refers to a general purpose computer that could connect to the internet or to a local or wide area network, including a personal desktop, a laptop or notebook, a personal digital assistant (PDA), a handheld used as a computer and communications device, and other portable computers alike. The term “networked computer” refers to a computer that is connected to the internet or to a local or wide area network. “Predetermined schedule” term refers to predetermined vehicle related matters to occur or to be done at or during a particular time or period (e.g. manufacturer's maintenance schedule, official motor vehicle obligation). “Provisioning” refers to network point's specific behavior database formatting and default initialization. “Commissioning” refers to assigning network point specific functionality and setup of related parameters including threshold limits, data polling time, data records format, power control settings, and activation control. “Thread” refers to a portion of a program that can run independently of and concurrently with other portions of the program. The term “software module” or “module” refers to a self-contain program that carries out a specific task comprising one or more threads.

Hereinafter, the present invention will be described in detail with reference to the attached drawings.

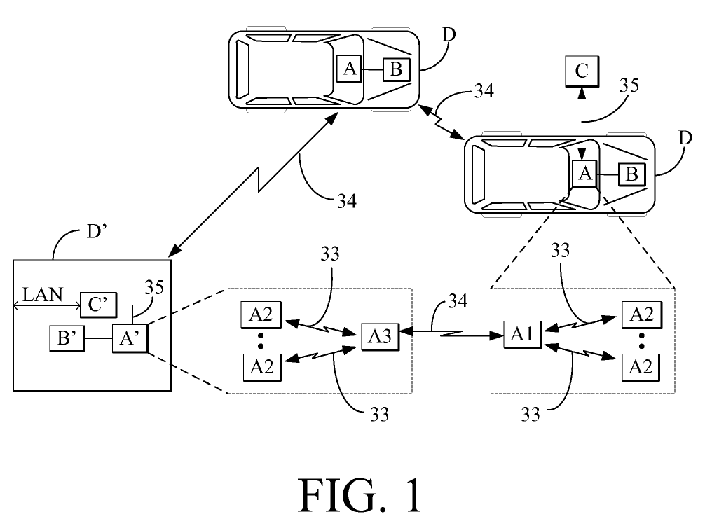

Referring to FIG. 1, each vehicle D is equipped with an OVAS A powered through vehicle's power supply B, a public or private premise D′ is furnished with an ILAS A′ powered through a regulated DC battery power supply B′. An OVAS A system oversees vehicle conditions, records and conveys perceived vehicle concerns to the driver locally (e.g., playing voice prompts and displaying text and graphical messages) or to a temporary connected computer C through flexible port 35. An ILAS A′ system is placed as a stationary hub able to communicate with other surrounding compatible systems and could be permanently connected to an in-location networked computer C′ via flexible port 35.

OVAS A comprises various system components including a plurality of in-vehicle IPUs A2 interacting through short range intra-wireless link 33 with respective MPU A1. A mobile network hub point MPU A1 could communicate with other compatible hub points via extra-wireless link 34. By the same token, ILAS A′ comprises various system components including in-location IPUs A2 interacting through short range intra-wireless link 33 with respective SPU A3. A stationary network hub point SPU A3 could communicate with other compatible hub points via extra-wireless link 34.

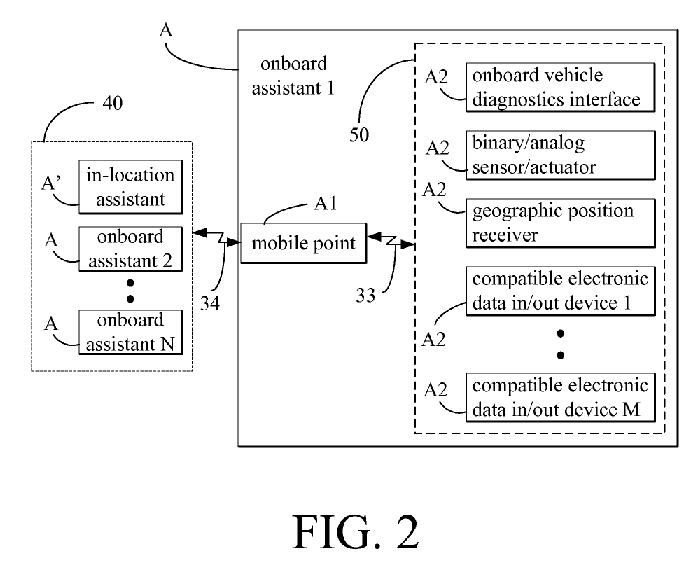

FIG. 2 is a block diagram of an onboard OVAS A mobile intranet, depicting examples of multiple IPUs A2 installed in a vehicle 50, linked to respective MPU A1 via intra-wireless link 33, as the means to set and collect vehicle's conditions as commanded by the mobile point MPU A1. Several onboard OVAS A assistants and in-location ILAS A′ assistants could interact among themselves, through extra-wireless link 34, forming mixed-mesh network 40. MPU A1 could gather in-vehicle and surrounding data conditions from different sources including local behavior database allocated on non-volatile memory device 22, real time in-vehicle logging data collected from respective intranet IPUs A2, and vehicle surrounding logging data from compatible network hub points 40 (e.g., SPU A3, other MPU A1). Once all data conditions (logging data) are stored, MPU A1 could determine relevant vehicle logging information (e.g., pre-scheduled data, anomalies, statistics), and deliver the pertinent message to the driver by playing a sound effect and voice prompt and showing a related visual message.

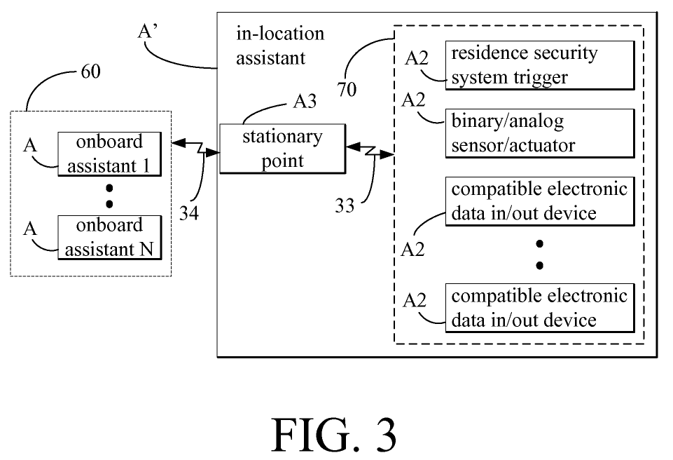

FIG. 3 is a block diagram of an in-location ILAS A′ stationary intranet, depicting examples of multiple IPUs A2 installed in location 70, linked to respective SPU A3 via intra-wireless link 33, as the means to set and collect premise conditions commanded by the stationary point SPU A3. Several on board OVAS A assistants could interact among themselves, through extra-wireless link 34, forming mobile-mesh network 60. SPU A3 functionality could be as a gateway connecting a in-vehicle assistant OVAS A to an in-location networked computer, as a network hub point interacting with in-location IPUs A2, and as stand-alone where the SPU A3 is tied to an electronic data EDD 32 device.

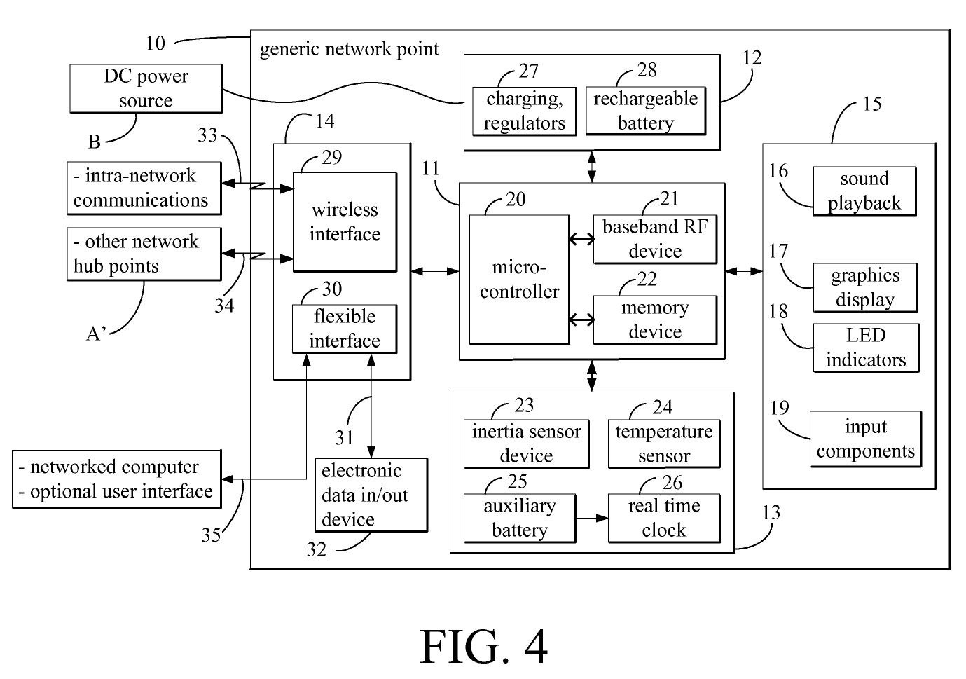

FIG. 4 is a block diagram of wireless generic-network point unit (GPU) 10 hardware architecture. A GPU 10 provides flexible embedded hardware to facilitate embodying one of several wireless network point unit profiles (e.g., IPU A2, MPU A1, SPU A3), by assembling and programming required components only. A GPU 10 comprises several hardware blocks including:
1) a microcomputer BBM block 11 that is GPU 10 board's processing core comprising a microcontroller 20, baseband and RF component 21 providing physical layer functionality for wireless protocol stack, and non-volatile memory device 22 to store desired profile point unit behavior database among other data;
2) a power circuitry block 12 which consists of a battery's charging components and board power voltage regulation 27, energized from a vehicle power supply or regulated direct current (DC) power supply, and rechargeable battery 28. Power circuitry is monitored and controlled to minimize power consumption;
3) a communications block 14 that provides wireless interface 29, and flexible interface 30, to interact with different system components based on network point profile functionality. For example:
   a) a network point unit profile assembled and programmed as a MPU A1 board, then, MPU A1 could to interact with different system components including respective in-vehicle IPUs A2 through a intra-wireless link 33, other mobile or stationary compatible systems ILAS A′ via extra-wireless link 34, temporary connected computer C, shown in FIG. 1, through flexible port 35 for system service and configuration, or alternative user interface by running a custom software widget for an enhanced user interface experience; and, alternatively, an EDD 32 through extended port 31 for stand-alone functionality;
   b) a network point unit profile assembled and programmed as an IPU A2 board, then, IPU A2 could interact with other system components including MPU A1 or SPU A3 network hub point controllers within OVAS A or ILAS A′ systems respectively via intra-wireless link 33, an EDD 32 attached through extended port 31, and an alternative temporarily connected computer via flexible port 35 for IPU A2 provisioning and commissioning; and
   c) a network point unit profile assembled and programmed as a SPU A3 board, then, SPU A3 could interact with different system components including respective in-location IPUs A2 via intra-wireless link 33, mobile compatible systems OVAS A via extra-wireless link 34, permanently connected to an in-location networked computer C′, shown in FIG. 1, through flexible port 35 for gateway functionality enabling the applications such as:
      i) auto shop sign-in office. A SPU A3 can be used at auto repair shops to engage with an OVAS A to retrieve diagnostics and maintenance records to expedite the auto shop work order process. The stationary point A3 will convey vehicle information to an in-shop networked computer to retrieve and update vehicle repair and maintenance data records; and
      ii) vehicle parking security. A SPU A3 can be used at public or private parking to engage with a finite number of vehicles equipped with OVAS A forming a wireless mesh network. Each vehicle is polled to convey security status information to SPU A3, which in turn conveys received status information to in-location network computer,
   alternatively, for stand-alone functionality, an EDD 32 device could be tied on extended port 31;
4) an on board embedded devices 13 including: inertia sensor device 23 which provides relative perpendicular axis vehicle inertia data to calculate vehicle vibration, tilt, skid, and sudden deceleration; temperature sensor 24 and RTC 26 used for chronological sensitive data recording, and auxiliary battery 25 for RTC data back up;
5) a user interface block 15 composed of sound playback device 16, a graphics display device 17, LED indicators 18, and input components 19 (e.g., touch sensitive interface, buttons, joystick); and
6) an electronic data in/out block EDD 32 (e.g., geographical coordinate device, in-vehicle diagnostics interface, residential security alarm trigger element, binary or analog sensor, binary or analog actuator) connected to flexible interface block 30 via extended port 31.
   A MPU A1 and SPUA3 boards could be each embodied with a fully assembled board GPU 10, where EDD block 32 is optional and excludes inertia sensor device 23 for SPUA3 profile board. An IPU A2 board could exclude inertia sensor device 23, EDD 32 is tied via extended port 31 to flexible interface 30, and minimizes user interface 15 to LED indicators 18. As such, LED indicators 18 could encode different IPU A2 states by changing flashing speeds, intensity and binary LED combinations. For example, if there are two LED indicators (e.g., LED_1. LED_2, LED_3, and LED_4), IPU A2 operation states could be encoded as follows:

1) IPU A2 Active—LED_1 flashing;

2) IPU A2 Sleeping—LED_1 lowest intensity;

3) IPU A2 Low Battery—LED_2 medium intensity;

4) IPU A2 Error—LED_2 flashing.

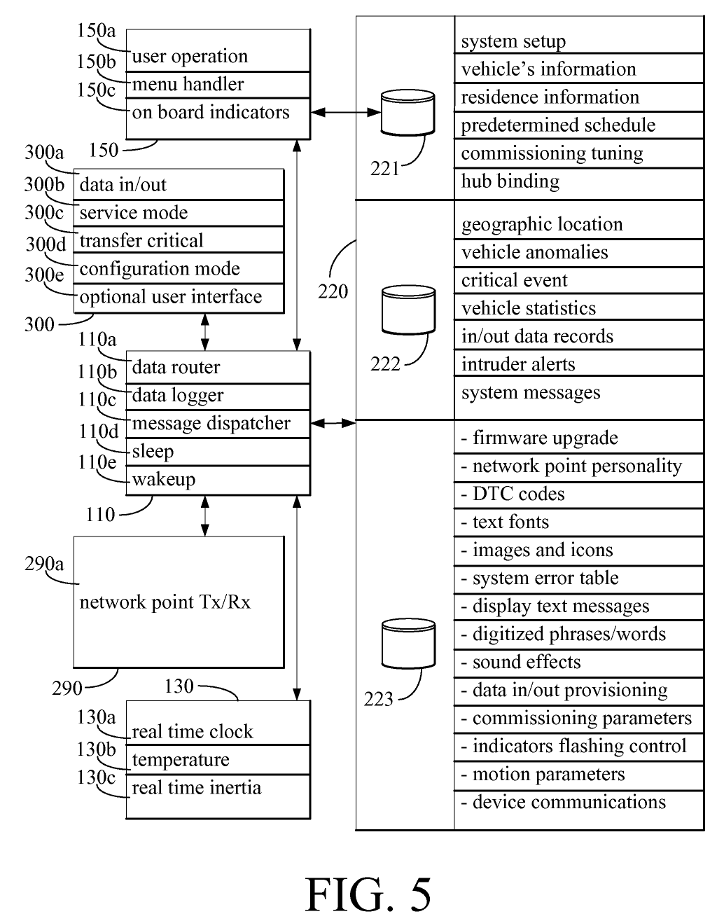

FIG. 5 represents a block diagram of generic-network point unit software architecture. Once a generic-network point's behavior database 220 is formatted and initialized, the generic-network board 10 is programmed with a specific network point profile (e.g., MPU A1, IPU A2 or SPU A3). The behavior database 220 is subdivided into data segments such as user settings 221, logging data 222, and configuration data 223. Each data segment has fields and parameters that correspond to specific network point profile. For instance, some fields and parameters assigned for intra profile IPU A2 functionality are commissioning tuning and hub binding within data segment user settings 221, and data in/out provisioning and commissioning parameters under the configuration data 223 segment. An IPU A2 provides software flexibility to be provisioned for the data in/out thread 300a, under flexible interface module 300, based on specific EDD 32 functionality and commissioned accordingly by configuration data 223 and respective user settings 221, allowing IPU A2 to run specific firmware with respective configuration. Provisioning and commissioning are interrelated activities of the IPU A2 deployment process that sets out intra behavior database 220 for proper EDD 32 interface, protocol and data in/out handling. For example, if the EDD 32 is a Global Positioning System receiver (GPS) or similar device used to determine geographic position data, the IPU A2 will be provisioned with GPS data in/out profile or compatible software thread and commissioned through configuration data 223 setup by specific application requirements. In another example, if the EDD 32 is a reed relay, the IPU A2 will be provisioned to control a specific binary output from the flexible interface 30 to activate or de-activate relay trigger signal according to tuned commissioning parameters.

By the same token, threads are executed based on specific network point personality conformed by configuration data 223 segment. For instance, some threads excluded for network point IPU A2 functionality are user operation 150a and menu handler 150b within user interaction module 150, and optional user interface 300e under flexible interface module 300. On the other hand, some threads always included for IPU A2 profile, but could be excluded for MPU A1 and SPUA3 profile functionality, are sleep 110d and wakeup 110e under core management module 110, and on board indicators 150c under user interaction module 150.

There are some software threads that are optionally included, based on network point personality settings. For instance, real time inertia 130c and temperature 130b threads within on board data module 130, could be included if the IPU A2 has been provisioned and commissioned to monitor inertia data, is always included for MPU A1. Also, data in/out thread 300a is always included for IPU A2 and could be included for MPU A1 and SPUA3 if such hubs have been set for stand alone functionality in network point personality settings under configuration data 223 segment.

Since one of the features of a network point is to be able to transmit and receive data over a wireless link, for intra and extra network communications, the wireless network module 290 always includes a network point transmit/receive (Tx/Rx) thread 290a. Other common software threads across any network point profile are: (1) service mode 300b, transfer critical 300c and configuration mode 300d within flexible interface module 300; (2) real time clock 130a under on board data module 130; and (3) data router 110a, data logger 110b, and message dispatcher 110c within core management module 110.

A network computer connected to the flexible interface 30 via flexible port 35, could trigger different flexible interface module 300 modes, by providing a predetermined American National Standards Institute (ANSI) character sequence (e.g., “*ab1*”, “*ab2*”, “*ab3*”, “*ab4*”) when a network point unit is waiting for specific ANSI character sequences as part of the network point unit rebooting sequence. For instance: (1) sequence “*ab1*” could activate service mode 300b, which is used to set network system setup, vehicle information, predetermined schedule alerts, and network point test and debug; (2) sequence “*ab2*” could activate transfer critical 300c, which is a mode where vehicle's critical event time/date stamp data (e.g., geographical location, three axis inertia data, speed revolutions per minute (RPM), temperature, diagnostics trouble codes (DTC)) is transferred from MPU A1 to a computer C; (3) sequence “*ab3*” could activate configuration mode 300d, which enables firmware upgrade and transfer of configuration files including images, fonts, text messages, vehicle's DTC, voice prompts, and sound effect; and (4) sequence “*ab4*” could activate optional user interface thread 300e, which allows a network hub point to divert any user interface interaction to the connected computer C executing a software widget to enhance the user interface experience.

The network point's wireless communications are managed by a network point Tx/Rx thread 290a for transmitting and receiving different inter-network messages 500 with subtype 504 and respective category 505. For example: (1) “LOGGING” categories could be inertia, RTC, temperature, geo-location, diagnostics anomalies, sensor/actuator, trip distance, trip top speed, parking time between trips, critical event, and system messages 400; and (2) “COMMAND” categories could be ping request, ping response, activate, deactivate, abort, reset, battery life, data logged request, and data logged response.

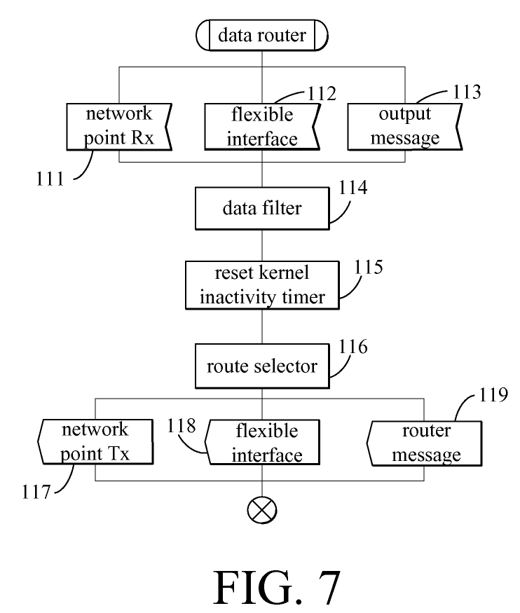

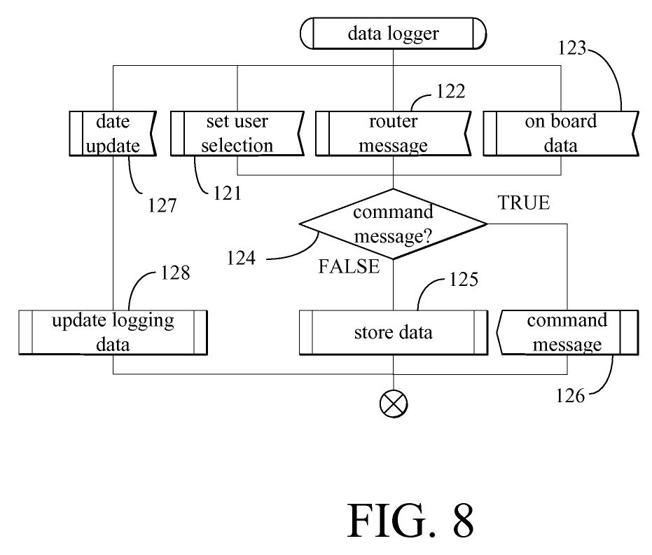

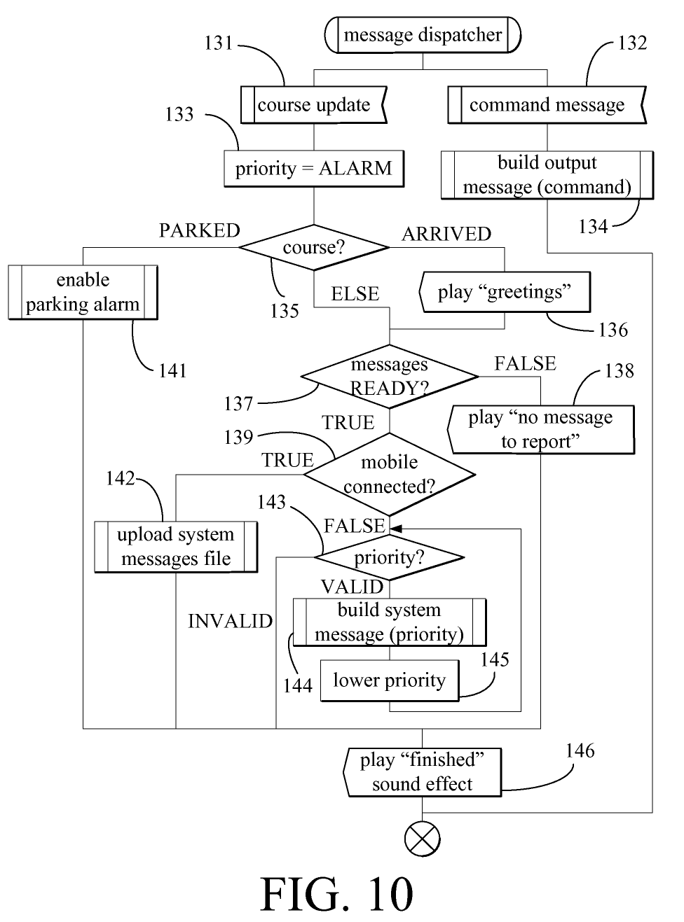

Inter-network type messages 500 inward/outward of network point unit are built, decoded, encoded, processed, logged, and routed by core management module 110 executing data router thread 110a detailed in FIG. 7, data logger thread 110b decomposed in FIG. 8, and message dispatcher thread 110c depicted in FIG. 10. Messages are classified in two different types: 1) system message 400 which is generated based on vehicle conditions and could be conveyed to the driver as visual and sound message; and 2) inter-network message 500 which frames and conveys data and commands across the different entities interacting (e.g., MPU A1, IPU A2, SPUA3, EDD 32, computer C, networked computer C′).

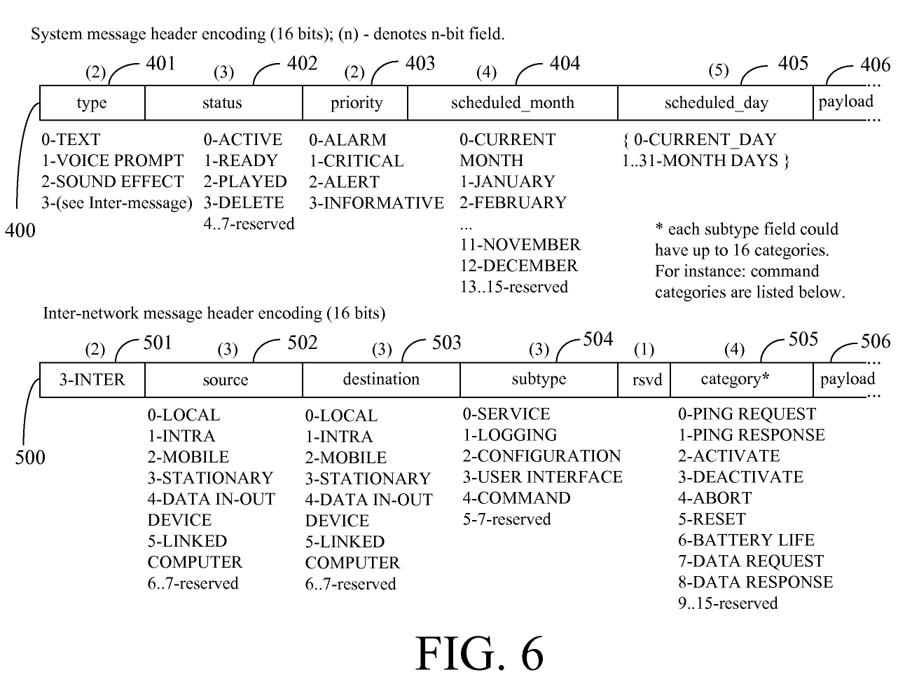

FIG. 6 shows details of system message 400 (with “type” field 401 set to either “TEXT”, “VOICE PROMPT”, or “SOUND EFFECT”) and inter-network message 500 (with “type” field 501 set to “INTER”) headers definition. An IPU A2 is virtually bound to a specific network hub point to transmit and receive inter-network messages 500. When an IPU A2 detects a sensor triggered by a parked vehicle intrusion, would generate logging data “ALARM” priority level 403. An IPU A2 detecting a fatal or critical vehicle situation through diagnostics interface or safety sensor attached, would generate a logging data “CRITICAL” priority level 403. Pre-scheduled data whether generated internally (e.g., motor oil change, transmission oil change, tire rotation, air filter change, spark plugs check, coolant change), set on user settings segment 221 (e.g., official vehicle inspection due, official registration due, etc), or triggered by different vehicle surrounding circumstances monitored through IPU A2 attached with proper sensors (e.g., “prepare your umbrella”, “scanning for system messages”, “no system messages to report”, “activate display for system message details”, “rear left door is open”, “hide valuables from sight”, etc), would generate logging data “ALERT” priority level 403. Statistics and non-scheduled information (e.g., time driven per day/week/month, distance driven per day/week/month, etc), would generate logging data “INFORMATIVE” priority level 403. Inter-network message payload 506 could be logging data which comprises a system message header 400 and data information payload 406 specific to “LOGGING” subtype 504 and respective category 505.

Every message in and out of the network point passes through the data router thread 110a for message integrity verification, and if correct, is then forwarded to next respective thread for further handling and processing. The data router thread 110a, shown in FIG. 7, executes whenever either of the following events are triggered: a message from network point Tx/Rx 290a is received 111; logging data from flexible interface module 300 is received 112; and an output message from message dispatcher thread 110c, decomposed in FIG. 10, is received 113. The message is taken from respective data router thread 110a input queue and filtered 114 ensuring message is valid by ensuring message integrity, valid logical source address 502, and the rest of message header consistency. Then, the inactivity timer is reset 115 avoiding entering into a sleep mode thread 110d, then, a route selector function 116 looks into the message logical destination entity 503 (e.g., “LOCAL”, “INTRA”, “MOBILE”, “STATIONARY”, “DATA IN/OUT DEVICE”, “LINKED COMPUTER”) and conveys the message to either network point Tx/Rx thread 290a transmitting queue 117, or flexible interface module 300 output queue 118, or forwards message to data logger thread 110b event input queue 119 for further handling and processing.

FIG. 8 depicts a detailed flowchart for the data logger thread 110b. The data logger thread 110b is a message storing, updating and handling engine triggered by different inter-network messages 500 such as date update 127 generated locally based on RTC time/date information, user interaction 121 generated locally or from a linked computer C (message subtype field 504 “USER INTERFACE”), a router message 122 forwarded from data router thread 110a (e.g., message subtype field 504 “SERVICE”, “LOGGING”, “CONFIGURATION”, “COMMAND”), or locally generated on board data message 123 (e.g., on board soldered inertia sensor, on board soldered temperature sensor). If the received message has subtype field 504 set to “COMMAND” 124 then it is conveyed to the message dispatcher thread 110c event input queue 126 for further processing, otherwise it is processed by store data function 125 which sets message status field 402 to “READY” if current date matches message header fields scheduled month 404 and scheduled day 405, or message priority level field 403 is set to either “ALARM” or “CRITICAL”. Otherwise message status field 402 is set to “ACTIVE”. The message is stored on non-volatile memory 22 in the respective behavior database segment (e.g., user settings 221, logging data 222, or configuration data 223). Once every 24 hours, a date update message 127 is issued, triggering update logging data function 128 which sets message status field 402 to “READY” if header fields scheduled month 404 and scheduled day 405 match current date, also, system messages with status field 402 set to “PLAYED” are changed to “DELETE”, and removes system messages status field 402 set to “DELETE” from the day before.

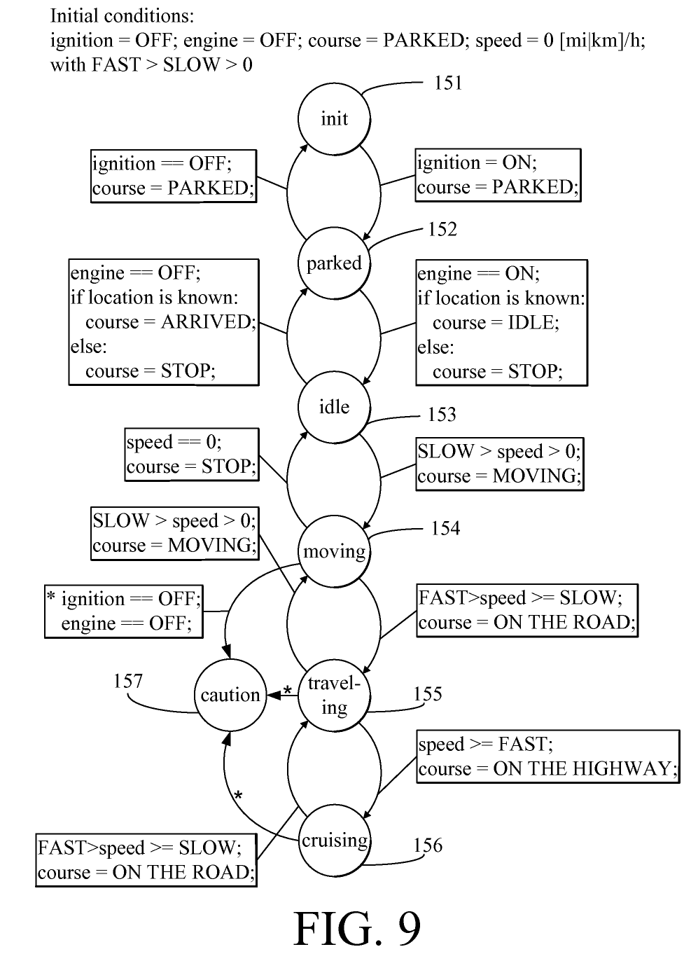

FIG. 9 depicts a state machine diagram as a mechanism to monitor vehicle trip status held in “course” variable and calculation of vehicle trip statistics such as “parking time”, “trip top speed”, “trip distance”, “vehicle location”, and others trip related statistics. The vehicle trip state machine dynamics is triggered by event variables such as “ignition” set to ON/OFF, “engine” set to ON/OFF, and “speed” from zero to maximum vehicle speed with “SLOW” and “FAST” thresholds as shown on Table 1.

TABLE 1
Vehicle trip state machine transition table

| | event | | | | | | | |
|---|---|---|---|---|---|---|---|---|
| | ignition | | engine | | speed | | | |
| state machine | ON | OFF | ON | OFF | zero | >0 and <SLOW | >=SLOW and <FAST | >=FAST |
| s0-init | s1 | s0 | s1 | s1 | s1 | s1 | s1 | s1 |
| s1-parked | s1 | s0 | s2 | s1 | s2 | s2 | s2 | s2 |
| s2-idle | s2 | s1 | s2 | s1 | s2 | s3 | s3 | s3 |
| s3-moving | s3 | s6 | s3 | s6 | s2 | s3 | s4 | s4 |
| s4-traveling | s4 | s6 | s4 | s6 | s3 | s3 | s4 | s5 |
| s5-cruising | s5 | s6 | s5 | s6 | s4 | s4 | s4 | s5 |
| s6-caution | s1 | s0 | s2 | s0 | s0 | s0 | s0 | s0 |

Referring to FIG. 9, while in “init” state 151, if “ignition” switch is turned ON, then, “parked” state 152 is activated. Once in “parked” state 152, “idle” state 153 is activated if engine is started (“engine” switched ON) and if vehicle speed reaches “SLOW”, then, state “moving” 154 is activated. Once in “moving” state 154, “traveling” state 155 is activated if vehicle speed reaches between “SLOW” and “FAST”. If while in “traveling” state 155 the vehicle speed reaches “FAST” and beyond, the state “cruising” 156 is triggered. If while “cruising” state 156, speed goes between “SLOW” and “FAST”, then “traveling” state 155 is triggered back. While in “traveling” state 155, if vehicle speed goes between “SLOW” and zero, then, “moving” state 154 is triggered back. While in “moving” state 154, if car stops (“vehicle speed” equal zero), then “idle” state 153 is triggered back. While in “idle” state 153, if engine stops (“engine” turned OFF), then “parked” state 152 is triggered back. While in “parked” state 152, if “ignition” switch is OFF, then “init” state 151 is triggered back. Additionally, “caution” state 157 is considered for those unexpected and uncommon circumstances. For example, if the engine is turned OFF while the vehicle is either in “moving” state 154, “traveling” state 155, or “cruising” state 156, the “caution” state 157 is triggered. While in “caution” state 157, a message priority level field 403 “CRITICAL” with respective payload data 406 set with current critical vehicle conditions (e.g., vehicle DTCs, RPM value, vehicle speed, inertia data, time, date, geographical coordinates).

Variable “course” status is set as follows:
1) vehicle is in “PARKED” status when vehicle “ignition” is OFF;
2) vehicle could be in “ARRIVED” status when engine is OFF, the parking location comes nearly exact to a known geographical location stored on user settings 221, and vehicle during current trip reached “FAST” cruise speed;
3) vehicle could be in “IDLE” status when “engine” is ON, the parking location comes nearly exact to a known geographical location stored on user settings 221, and previous “course” status was “PARKED”;
4) vehicle is in “ON THE ROAD” status when vehicle speed is between “SLOW” and “FAST”;
5) vehicle is in “ON THE HIGHWAY” status when vehicle speed is equal or above “FAST”;
6) vehicle is in “MOVING” status when vehicle speed is above zero and below “FAST”; and
7) vehicle is in “STOP” status when vehicle speed is zero, vehicle location does not match any known geographical location stored on user settings 221, and “ignition” is ON. Every time “course” status changes, a message course update 131 is issued to the system. Vehicle trip statistics are calculated as follows:
1) “parking time” timer is reset and started when vehicle status changes to “PARKED”, and stops when for the first time during the trip, while in “idle” state vehicle status changes to “MOVING”, current timer value is stored as “parking time” under vehicle statistics on logging data segment 222;
2) “trip top speed” is monitored while in “cruising” and is stored as “trip top speed” under vehicle statistics on logging data segment 222;
3) “trip distance” is calculated based on distance accumulated between “IDLE”, after “parked” to “idle” transition, and “ARRIVED” status;

The “message dispatcher” thread depicted in FIG. 10, is the main engine to build system messages 400 (when vehicle trip “status” changes 131), and inter-network messages 500 (when requested through “command” message 132). Messages are built based on condition records (e.g., pre-scheduled, statistics, and real time generated) and user/configuration settings residing on behavior database 220. A specific command message request 132 is handled by the “build output message” function 134 which decodes inter-network message header category 505 and builds message response if applicable (e.g., ping request/response, battery life, data request/response), or executes command accordingly. Once a vehicle trip status event 131 is detected, loop variable is set to highest “ALARM” priority level 133 to convey to the driver system messages starting from highest to lowest priority level “INFORMATIVE” as shown in Table 2. Vehicle trip status is validated 135 as follows:
1) case “PARKED”, vehicle parking alarm is set ON 141;
2) case “ARRIVED”, indicates vehicle has been parked at a location nearly exact to a known geographical location stored on user settings 221, consequently greeting messages are played 136 accordingly (e.g., “home sweet home” if location is home, “lets get the project done” if at work office, “good morning” if time before noon, etc) before “READY” message status 402 are seek 137.
3) case “ELSE”, indicates vehicle could be in “IDLE”, “STOP”, “ON THE ROAD”, “ON THE HIGHWAY”, or “MOVING” status, which enables system messages priorities 403 “CRITICAL”, “ALERT”, “INFORMATIVE” conveyed to the driver.
   If seeking “READY” messages status 402 is successful then:
1) if a computer is linked 139 to respective MPU A1, then MPU A1 transfers all “READY” system messages 142 for their processing by a software widget resident on the computer;
2) otherwise, while priority level is valid 143, system messages 400 type text, voice prompts, and sound effects 401 are generated on “build system message” function 144 to be shown on graphic display and played on sound playback device, then priority level is lowered 145 and loops back to seek for next “READY” system messages with lower but valid priority 143. Once every “READY” system message is conveyed to the driver, message status is set to “PLAYED”. Once all system messages were set to “PLAYED”, then, a “finished” sound effect is played 146. In the case where there were no “READY” system messages 137, then, “no message to report” voice prompt is played 138.

TABLE 2
System messages priority definitions and respective vehicle trip
status trigger options used in FIG. 10

| priority level | priority name | respective vehicle trip status trigger |
|---|---|---|
| highest | ALARM | PARKED |
| high | CRITICAL | IDLE/ARRIVED/STOP/MOVING/ |
| | | ON THE ROAD/ON THE HIGHWAY |
| low | ALERT | IDLE/ARRIVED |
| lowest | INFORMATIVE | ARRIVED |

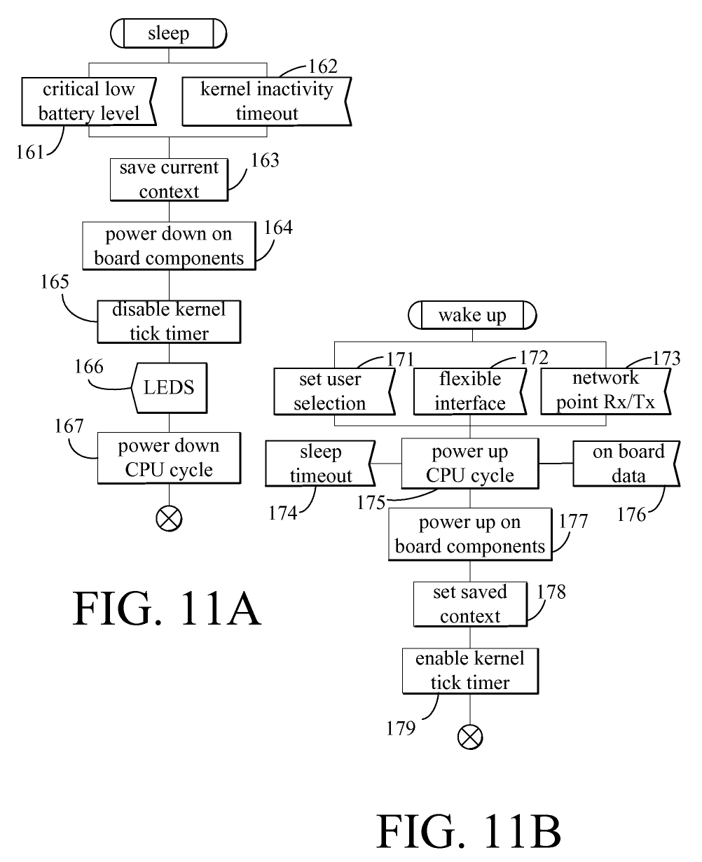

Referring to FIG. 11A, whenever the critical low battery level event 161 or kernel inactivity timer timeout event 162, network point IPU A2 enters into “sleep” mode, which immediately saves current context 163 by storing into flash memory kernel status parameters, tasks active, thread queues, events, messages, current stack pointer, PC, and other processor registers, then, starts power down non-critical embedded components 164, disables kernel tick timer 165 and sets LED indicator interface 166 to show low battery and last it enters into a self power down CPU cycle 167. FIG. 11B, shows a “wake up” mode thread flowchart, which is executed only after CPU entered in sleep mode and kernel timer tick is disabled. The wake up thread could be triggered by various interruption events including user input selection 171, a message to transmit or message received interruption signal from flexible interface 172, an inter-network message 500 received or to be transmitted 173, a sleep mode timer timeout 174 event, and on board data interruption 176 (e.g., RTC alarms, critical inertia data, critical temperature data). Once any of the events listed above is triggered, a power up CPU cycle is executed 175, then, non-critical embedded devices are powered in sequence 177, followed by previous saved context recover 178 and finally enable kernel tick timer 179, to let real time kernel take over the network point unit operational functions.

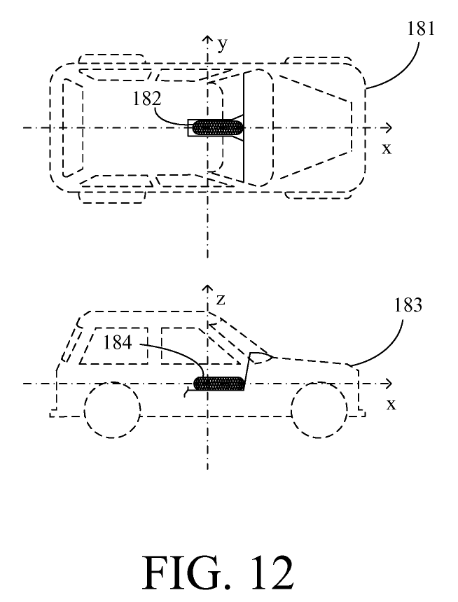

FIG. 12 shows a preferred MPU A1 in-vehicle installation. Top view 181 shows the preferred space between the driver and passenger seats 182, or side view 183 in the middle dashboard extension area 184, ensuring inertia sensor 23 readings represent vehicle's center front chassis motion.

While the above description contains many specifications, these should not be construed as limitations on the scope of any embodiment, but as exemplifications of the preferred embodiments thereof. It will be understood by those who practice the invention and by those skilled in the art, that various modifications and improvements may be made to the invention without departing from the spirit or scope of the invention as defined by the appended claims.

The embodiments of the invention in which an exclusive property or privilege is claimed are defined as follows:

What is claim is:

1. A method for communicating automotive vehicle care advice to an owner or occupant, which gathers and process vehicle conditions data to generate concise messages, comprising:
a) providing an in-vehicle (mobile) and an in-location (stationary) wireless intranet systems, installed in vehicle and furnished said in private or public premise locations respectively;
i) wherein each intranet comprises a short range wireless networking between a plurality of said intranet end nodes and said network hub node;
ii) wherein each intranet end node is tied to a said electronic data input/output device, from which said intranet end node obtains data to be locally processed and stored for transmission to the associated said wireless;
iii) wherein each network hub node executes vehicle care advisor program, collects data from respective intranet end nodes, communicates with other intranets, and provides user interface functions for owner or vehicle occupant interaction with the system.
b) providing current vehicle conditions data said diagnostics trouble codes, vehicle location data said geographical coordinates, predetermined schedule messages said automaker vehicle maintenance alerts or official motor vehicle obligations said vehicle inspection due and vehicle registration due.
c) providing means for logging and retrieve vehicle condition tagged with a system message header comprising said message type, status, priority and schedule date.
d) providing a user-system interaction data library said a set of pre-determined display messages, a collection of digitized phrases/words, and a variety of sound effects which said can be used to build up user system messages played said through display and/or sound playback device;
e) providing vehicle trip status information which said can be use to indicate whether vehicle said is parked, idle, stop, just arrived, moving—below a given low speed, on the road—between a given low and high speed, on the highway—above a given high speed;
whereby said the in-vehicle mounted intranet system will interact with vehicle owner or occupant providing a set of auto-generated system messages conveyed from highest to lowest priority level, comprising the steps of:
i) detecting vehicle trip status trigger event transition;
ii) seeking tagged with ready system messages matching current vehicle trip status;
iii) generating “greeting” messages according with current vehicle conditions, time and date; and
iv) activating “greeting” message when acknowledged by the vehicle owner or occupant, followed by system messages conveyed from highest to lowest priority level.

2) The method of claim 1, wherein said inter-network message conveys data and commands inward and outward of said a network hub or end node.

3) The method of claim 1, wherein said inter-network message contains said vehicle condition data that could be logged and later retrieved as said system message.

4) The method of claim 1, wherein said system memory is able to store system data segmented as said user settings, logging data and configuration data to conform a said network node behavior database.

5) The method of claim 1, wherein said system executes the vehicle care advisor program which comprises program parts for message processing said: formatting; receiving; dispatching; header filtering; classification and logging; and retrieving, power management to prolong said system rechargeable battery energy, continuous vehicle trip status monitoring, and user interface functionality for vehicle owner or occupant system interaction.

6) The method of claim 1, wherein said system will determine whether the vehicle is near to a pre-determined geographic location.

7) The method of claim 1, further comprising extranet communications with said other compatible in-vehicle intranet systems forming mobile mesh networking communications to said exchange its own and other near vehicles security alarm status.

8) The method of claim 7, further comprising extranet communications with said other compatible in-location intranet systems, said furnished in a public or private parking lot, to covey security status information from each vehicle forming the mobile mesh networking further conveyed to an in-location computer.

9) The method of claim 1, further comprising extranet communications with said other compatible in-location intranet system, said furnished in residential/home premise, to exchange information said vehicle operation and performance statistics records further conveyed to an in-location computer.

10) The method of claim 1, further comprising extranet communications with said other compatible in-location intranet system, said furnished in residential/home premise, to activate/deactivate said residential security alarm system switch said reed contact, wherein said reed contact is open/close according to said vehicle security status, said alarm state opens reed contact, otherwise switch is closed.

11) The method of claim 1, further comprising extranet communications with said other compatible in-location intranet systems, said furnished in auto shop sign-in office, to exchange information said vehicle diagnostics and maintenance records further conveyed to an said in-location networked computer executing an auto-shop custom program for said auto shop customer service.

12) The method of claim 1, further comprising extranet communications with portable devices, said cell phones with internet access and multimedia capabilities, wherein said system messages can be transferred and presented to the vehicle owner by executing a custom mobile widget.

13) A configurable embedded wireless communication system, comprising:
i) a wireless radio transceiver, a microcontroller and a non-volatile memory to enable wireless communications, data processing, and system data storage;
ii) power circuitry further comprising rechargeable battery and battery's charging as well as board power voltage regulation components, energized by battery of the vehicle or from in-location regulated direct current (DC) power supply;
iii) a configurable expansion interface to connect temporary to computers and attach to different in-vehicle electronic data in/out devices;
iv) means for three axis vehicle acceleration measurement, temperature measurement and keep track of current time, said three axes inertia sensor, temperature sensor and real time clock; and
v) user interface means for vehicle occupant interaction with vehicle care advisor system, said display, sound playback device, LEDs, and user inputs means said touch sensitive interface, buttons, and joystick.

14) A configurable embedded wireless communication system according to claim 13, wherein said the system represented as a circuit board could be assembled and programmed to embody said a mobile wireless network hub.

15) A configurable embedded wireless communication system according to claim 13, wherein said the system represented as a circuit board could be assembled and programmed to embody said a stationary wireless network hub.

16) A configurable embedded wireless communication system according to claim 13, wherein said the system represented as a circuit board could be assembled and programmed to embody said a wireless network end node.
